(19) United States
(12) Patent Application Publication
(10) Pub. No.: US 2021/0105943 A1
(43) Pub. Date: Apr. 15, 2021

(54) HEMP HARVESTING SYSTEM

(71) Applicant: GARY W. CLEM, INC., Nevada, IA (US)

(72) Inventors: Brian W. Carr, Ames, IA (US); Scott A. Sporrer, Nevada, IA (US); Christian G. Clem, Colo, IA (US); Larry J. Reed, Dallas Center, IA (US); Chris W. Wendt, Newton, IA (US); Ryan A. Carstensen, Bondurant, IA (US); Patrick H. Clem, Nevada, IA (US); Matthew T. Sobotka, Huxley, IA (US)

(21) Appl. No.: 17/066,557

(22) Filed: Oct. 9, 2020

Related U.S. Application Data
(60) Provisional application No. 62/912,706, filed on Oct. 9, 2019.

(51) Int. Cl. A01D 45/06

(52) U.S. Cl. CPC A01D 45/065

(57) ABSTRACT

A harvesting system having a housing with a cover, a first end wall, a second end wall, and a bottom wall. A rotatable assembly is mounted within the housing. The housing has a pair of housing sections separated by a gap to receive a plant having plant material. A guide member is attached to the housing to direct a plant into the gap. Also disposed within the housing is a material transport assembly adapted to transport plant material to a hopper or wagon. The rotatable member is adapted to strip and collect plant material.

### CROSS REFERENCE TO RELATED APPLICATION

This application claims the benefit of the priority of U.S. Provisional Application No. 62/912,706 filed on Oct. 9, 2019, the content of this application is hereby incorporated by reference in its entirety.

### BACKGROUND OF THE INVENTION

The present invention is directed to a harvesting system and more particularly a system to harvest plant material from a plant, such as hemp or the like, in a field at wet moisture.

While the harvesting system is described with respect to a hemp plant, the system is used with any type of plant to strip and collect the plant material from a stalk. Because the use and interest in hemp products has been increasing, the system is described in relation to a hemp plant as an example only. With respect to the plant material of a hemp plant, as opposed to the stalk and sticks (i.e., branches), the material can be used to produce a multitude of products including; CBD oil, smoking buds, fiber, and health products.

Presently, harvesting to strip the plant material from a hemp plant is a two-step process. First, the stems of the hemp plant are harvested, and sometimes dried. This step is expensive, as presently, plants are harvested by hand and it is difficult to find labor. Secondly, the stems are manually fed into a stripping machine. This process is time consuming and labor intensive. Getting product out of the field for drying is a significant problem. Accordingly, a need exists in the art for a system that overcomes these deficiencies.

An objective of the present invention is to provide a harvesting system that requires less time to harvest plants.

Another objective of the present invention is to provide a harvesting system that requires less labor to operate.

These and other objectives will be apparent to one having ordinary skill in the art based upon the following written description, claims and drawings.

### SUMMARY OF THE INVENTION

A harvesting system of the present invention is beneficial in that it produces less material to dry, is small and simple, capable of harvesting a single row if desired, and is gentle in handling the material reducing damage to the plant material. The harvesting system includes a housing having a cover, a first end wall, a second end wall and a bottom wall. Mounted within the housing is a rotatable assembly adapted to strip and collect plant material off of a plant. The housing is separated into two sections by a gap adapted to receive a plant, the pair of sections being mounted to a separating and lifting system. The space of the gap between the two sections is adjustable using the separating and lifting system.

The rotatable assembly has a pair of rotatable members each having a shaft with plant engaging members radially attached to the shaft. The rotatable assembly is adapted to strip plant material having both dry and wet moisture off a plant in a field. The rotatable speed of the rotatable assembly is adjustable and reversible. The rotatable members are also timed to rotate in multiple relationships to one another.

The housing is positioned at an angle with the first end wall adjacent a ground surface and the housing angles upwardly toward the second end wall. The system also has a material transport system to transport plant material to a hopper or wagon and a collection system positioned rear of a vehicle to collect the plant.

### BRIEF DESCRIPTION OF THE DRAWINGS

FIG. 1 is a side view of a harvesting system;

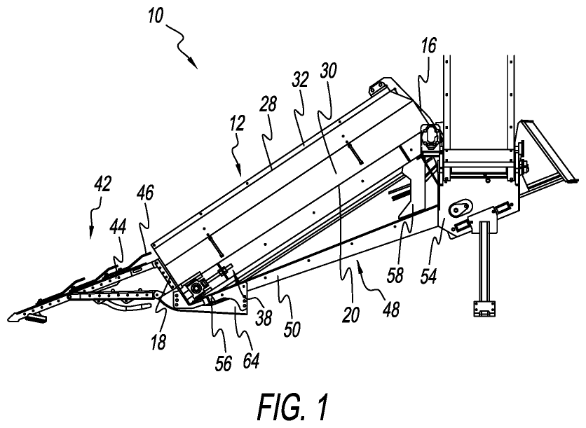

FIG. 2 is an end view of harvesting system;

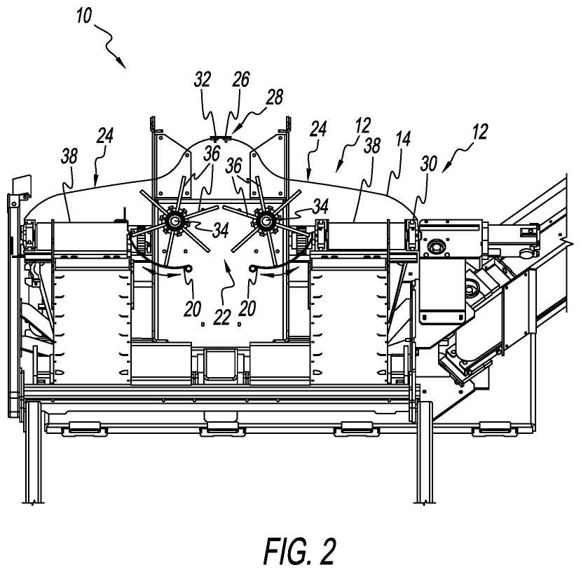

FIG. 3 is a top plan view of a harvesting system;

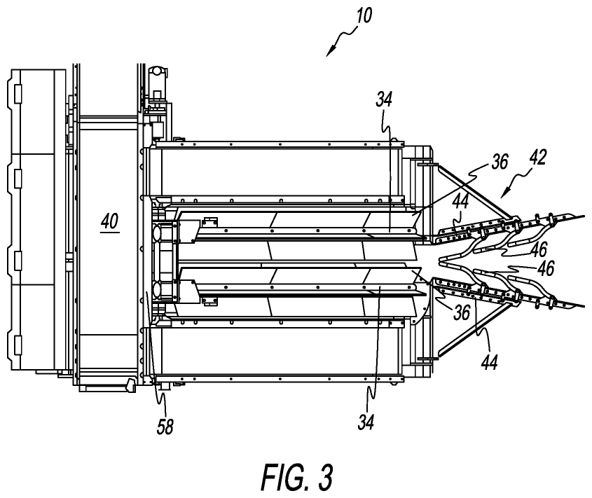

FIG. 4 is a perspective view of a harvesting system; and

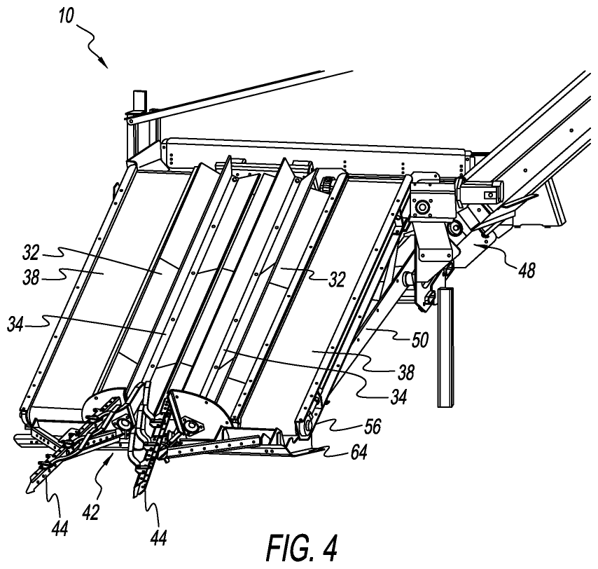

FIG. 5 is a schematic view of a harvesting system.

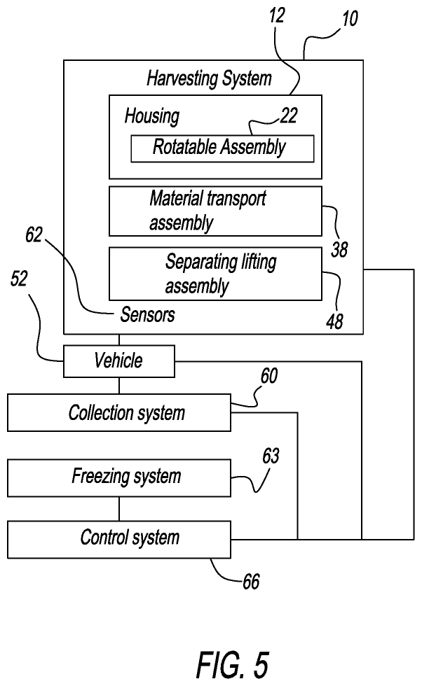

### DETAILED DESCRIPTION OF THE PREFERRED EMBODIMENTS

Referring to the Figures, a harvesting system 10 has a housing 12 that includes a cover 14, a first end wall 16, a second end wall 18, and a bottom wall 20. Mounted within the housing 12 is a rotatable assembly 22 adapted to strip and collect plant material off a plant. The housing 12 is separated into two sections 24 by a gap 26 adapted to receive a plant.

The cover 14 is of any size, shape and structure and has a first top edge 28 and a second bottom edge 30. Attached to the top edge 28 is a resilient member 32 that extends into the gap 26 and is positioned to engage a plant. The resilient member 32 is of any material such as rubber, brush bristles, steel or a combination of the like. The bottom wall 20 is of any size, shape, and structure. In a preferred example the bottom wall 20 is arcuate in shape and adjustably positioned below the rotatable assembly 22. The bottom wall 20 is adjustable both about the rotatable assembly 22 as well as toward and away from the rotatable assembly 22 to protect against loss of the plant material during the stripping and collecting process.

The rotatable assembly 22 is of any size, shape and structure. In a preferred example, the rotatable assembly 22 includes a pair of shafts 34 otatably mounted to the first 16 and second 18 end walls of the housing 12 and extending in parallel spaced relation. Attached along the length of the shafts are plant stripping members 36. The plant stripping members 36 are of any size, shape and structure such as bristles, rubber, tines, steel or similar combination of resilient material. The space between the shafts 34 and stripping members 36 is adjustable as well as the space between the cover 14 and the ends of the stripping members 36. The rotatable assembly 22 is driven by a motor (not shown) and preferably the shafts 34 and stripping members 36 rotate in opposite directions so that the stripping members 36 are rotating upwardly toward the cover 14 and away from the bottom wall 20 when the stripping members 36 are adjacent to one another. The speed of rotation and direction of rotation (i.e., reversible) of the shafts 34 are adjustable. The stripping members 36 are also adjustable and timed to interlock with one another, engage one another, or timed so that the ends touch.

Positioned between the rotatable assembly 22 and the bottom edge 30 of the housing 12 is a material transport assembly 38. The transport assembly 38 is of any size, shape and structure such as a conveyor, blower or the like. In the example shown a conveyor extends the length of the housing 12 and is positioned to receive plant material that has been stripped by the rotatable assembly 22 and transport the plant material to a wagon or hopper (not shown). In the example shown, a second conveyor 40 positioned transverse to the transport assembly 38 is used to transport plant material to the wagon or hopper.

Attached to the second end wall 18 is a guide member 42. The guide member 42 is of any size, shape and structure. In one example the guide member 42 has a pair of guide bars 44 that are angled away from one another as they extend away from the housing 12. Attached to the guide bars 44 are a plurality of fingers 46 that are preferably spring-loaded. In the example shown the fingers 46 are S-shaped. The fingers 46 extend into the space between the guide bars 44 and are positioned and adapted to apply pressure on a stalk of a plant and guide the plant into the gap 26 between the two sections 24 of the housing 12.

The sections 24 of the housing are connected to a separating and lifting system 48. The system 48 is of any size, shape and structure and in the example shown the system 48 includes a pair of parallel spaced support arms 50. The support arms 50 are attached to a vehicle 52 at a first end 54 and to the transport assembly 38 and the second end wall 28 of the housing at a second end 56. The vehicle 52 is of any type that preferably provides power and hydraulics including a prime mover, harvester, tractor, skid loader or the like. Positioned below the bottom wall 20 and adjacent the first end wall 16 is a cross bar 58 that is positioned to knock down the stalk of the plant after plant material has been stripped. Attached to the rear of the vehicle 52 is a collection system 60 that is positioned and adapted to cut and collect the stalk of the plant.

The housing sections 24 are connected to the support arms 50 of the separating and lifting system 48. The system 48 is adapted to move the arms 50 and housing sections 24 toward and away from one another to adjust the space of the gap 26 and the distance between the shafts 34 of the rotatable assembly 22. The system 48 is also adapted to raise and tilt the housing 12 so that the second end wall 18 is adjacent a ground surface while the first end wall 16 is raised from the ground surface to create an angle where the plant material is stripped from a low position on the stalk to a high position on the stalk as the plant travels through the gap 26 from the second end wall 18 to the first end wall 16. Sensors 62 are attached to the system 10 in order to adjust the height and angle of the housing 12, the speed of the vehicle 52, and the speed and direction of the rotatable assembly 22. The sensors 62 are also connected to a freezing system 63 that is positioned to flash freeze the plant material to preserve the quality of the material and reduce damage.

In one example, the support arms 50 of the separating and lifting system 48 are connected to a shoe or ski 64 at the second end 56. The shoe or ski 64 engages the ground surface and permits the second end 56 to adjust to the contour of the ground surface.

In operation the system 10 is connected to the vehicle 52 and using the separating and lifting system 48 the system is positioned to receive plants preferably at an angle and with the housing sections 24 and rotatable assembly separated to a desired distance. As the vehicle moves the system 10 toward the plants, the guide members 44 apply pressure to the stalk of the plant to hold the stalk out as it is guided by the spring loaded fingers 46 toward the gap 26.

As the plant enters the gap 26 the rotatable assembly 22 engages the plant material to strip the plant material from the stalk. The plant material is transported upwardly toward the cover 14 and along the contour of the cover 14 to the material transport assembly 38. That material transport assembly 38 transports the plant material to the second conveyor 40 and to the hopper or wagon. As the plant continues through the gap 26 the cross bar 58 engages the stalk and knocks the stalk down. As the vehicle 52 passes the plant the collection system 60 cuts and collects the stalk.

The rotatable assembly 22, material transport assembly 38, separating and lifting assembly 48, vehicle 52, collection system 60, and freezing system 63 are all connected to and operated at least in part by a control system 66 having a processor, software, memory and an input device.

From the above discussion and accompanying figures, it will be appreciated that a harvesting system 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A plant harvesting system, comprising:
a housing having a cover, a first end wall, a second end wall, and a bottom wall;
a rotatable assembly mounted within the housing and adapted to strip and collect plant material off of a plant.

2. The system of claim 1 wherein the housing is separated into two sections by a gap adapted to receive a plant.

3. The system of claim 2 wherein the two sections are mounted to a separating and lifting system.

4. The system of claim 1 wherein the rotatable assembly has a pair of rotatable members each having a shaft with plant engaging members radially attached to the shaft.

5. They system of claim 1 wherein a rotatable speed of the rotatable assembly is adjustable.

6. The system of claim 4 wherein a space between the pair of rotatable members is adjustable.

7. The system of claim 1 wherein the pair of rotatable members are timed to rotate in multiple relationships to one another.

8. The system of claim 1 wherein the rotatable assembly is adapted to strip plant material having wet or dry moisture off a plant in a field.

9. The system of claim 1 wherein the housing is positioned at an angle with the first end wall adjacent a ground surface and the housing angles upwardly toward the second end wall.

10. The system of claim 1 wherein a collection system is positioned to a rear of a vehicle and adapted to collect the plant.
